(19) United States
(12) Patent Application Publication
(10) Pub. No.: US 2023/0265854 A1
(43) Pub. Date: Aug. 24, 2023

(54) HANDHELD FAN WITH FAIRING

(71) Applicant: Shenzhen Zaiwan Technology Co., Ltd., Shenzhen (CN)

(72) Inventor: LIFANG CHEN, Shenzhen (CN)

(21) Appl. No.: 18/167,834

(22) Filed: Feb. 11, 2023

(30) Foreign Application Priority Data
Feb. 22, 2022 (CN) 202220357640.8

(51) Int. Cl. F04D 25/08; F04D 29/42; F04D 29/30; F04D 29/28; F04D 17/06

(52) U.S. Cl. CPC F04D 25/084; F04D 29/4253; F04D 29/30; F04D 29/281; F04D 17/06

(57) ABSTRACT

A handheld fan with a fairing has a fan head and a handle. The fan head is cylindrical and is provided with an air inlet, an air outlet, and a fluid passage connecting the air inlet and the air outlet. Air inlet vanes and air outlet vanes are disposed in the air inlet and the air outlet respectively. The fan head comprises a front cover and a rear cover that are fixedly connected. A fairing is disposed on inner sides of the front cover and the rear cover. The impeller is hidden in the fan head, so users will not be cut by blades when the blades rotate; the fairing is disposed in the fan head and is provided with the air inlet vanes and the air outlet vanes, so that all components of the fan can be injection-molded and assembled easily.

### CROSS-REFERENCE TO RELATED APPLICATIONS

This application claims the benefit and priority of Chinese Patent Application Number 202220357640.8, filed on Feb. 22, 2022, the disclosures of which are incorporated herein by reference in their entireties.

### BACKGROUND OF THE INVENTION

### 1. Technical Field

The invention relates to the technical field of fans, in particular to a handheld fan with a fairing.

### 2. Description of Related Art

Handheld fans are small and delicate structure, convenient to carry and capable of being used in a close proximity, thus being extremely popular. Most existing handheld fans use a motor to drive axial-flow blades, and air flows in from the rear end of the blades, and flows out from the front end of the blades after being pressurized by the blades.

Chinese Utility Model Patent Application No. CN201920805309.6 provides a portable fan, which can be pulled to be started, and comprises a locating shell, an outer shell and a movable cover, wherein fan blades are disposed outside the movable cover, an electric motor, a power supply and a control circuit board are disposed in the movable cover, and the fan blades can be folded to reduce the size, which makes the portable fan easy to carry.

However, the fan blades of existing handheld fans on the market are exposed, so in order to protect users from being cut by the fan blades, the fan blades are typically supported by flexible materials or the rotation speed of the fan blades has to be decreased, which makes the air output of the fans low and cooling effect of the fan unsatisfying.

### BRIEF SUMMARY OF THE INVENTION

One objective of the invention is to provide a handheld fan with a fairing to solve the above-mentioned problems.

To fulfill the above objective, the invention is fulfilled through the following technical solution:

A handheld fan with a fairing comprises a fan head and a handle, wherein the fan head is cylindrical and is provided with an air inlet, an air outlet, and a fluid passage connecting the air inlet and the air outlet, air inlet vanes and air outlet vanes are disposed in the air inlet and the air outlet respectively, the fan head comprises a front cover and a rear cover that are fixedly connected, a fairing is disposed on inner sides of the front cover and the rear cover, the center of the fairing is connected to a cavity through the air outlet vanes, a motor is installed in the cavity, an impeller is located outside the cavity after being connected to the motor, the fluid passage is formed between the cavity and the fairing, and the motor is able to drive the impeller to rotate to allow air to flow along the air inlet, the fluid passage and the air outlet. The impeller is hidden in the fan head, and fluid is gathered in the fluid passage, so that the air output is larger; and the fairing is arranged, so that all components of the fan can be injection-molded and assembled easily.

Preferably, a cross-sectional area of the air outlet is smaller than a cross-sectional area of the air inlet and a cross-sectional area of the fluid passage in the position of the impeller.

Preferably, the fairing at least comprises a front fairing portion and a rear fairing portion, the cavity and the motor are located in the front fairing portion, the impeller is located in the rear fairing portion, and limiting mechanisms for preventing circumferential rotation are disposed between the front fairing portion and the front cover, as well as between the rear fairing portion and the rear cover.

Preferably, the handle is fixedly connected to bottoms of the front cover and the rear cover, the front cover, the rear cover and the handle are internally communicated, a battery and a controller connected to the battery are disposed in the handle, the controller is connected to a switch and a charging port, and the fairing is provided with a hole allowing a wire to penetrate through to electrically connect the motor and the controller.

Preferably, a wire duct is formed in one air outlet vane and is communicated with the hole, the wire enters the wire duct after penetrating through the hole, and is isolated from the fluid passage, and a shield is disposed on the wire duct, and covers the wire duct after being installed.

Preferably, the motor is a DC brushless external rotor motor, the impeller comprises a hub and blades, a rotary shaft and a magnet are disposed in the hub, the blades are fixed on an outer side of the hub, and when the impeller and the motor are installed, the rotary shaft is inserted into the motor, and the magnet is located on an outer side of the motor.

Preferably, the multiple blades are spirally arranged and are spaced apart from each other, and cross-sections of every two adjacent said blades overlap in a direction of the rotary shaft.

Preferably, each blade has different widths at different positions of the hub, and a width of the blades at a first end is not greater than that of the blades at a second end.

Preferably, the hub is shaped like a cone or a frustum cone, and has the first end with a maximum diameter and the second end with a minimum diameter, and the first end is located at a position, with a maximum cross-sectional width, of the fan head.

Preferably, the blades extend towards the air inlet, and the motor is located downstream in an air flow direction.

Preferably, the handle is rotatably connected to a ring, a locating mechanism is disposed between the ring and the handle, and when the ring is located at a support position through the locating mechanism, the fan is erected or approximately erected on a horizontal table.

Compared with the prior art, the invention has the following beneficial effects: the impeller is hidden in the fan head, so users will not be cut by blades when the blades rotate; the distance between the impeller and the air outlet is extended, so that fluid is gathered in the fluid passage, air blown out of the air outlet is more concentrated, and a better cooling effect is created for users; the fairing is disposed in the fan head and is provided with the air inlet vanes and the air outlet vanes, so that all components of the fan can be injection-molded and assembled easily; the ring or the string is arranged, so that users can carry the fan by hanging the fan on their neck or on a backpack when going outside; and the ring can be used to support the fan when the fan is erected for use, so that the fan can be erected more steadily.

### BRIEF DESCRIPTION OF THE SEVERAL VIEWS OF THE DRAWINGS

FIG. 1 is a schematic diagram of a handheld fan according to the invention.

FIG. 2 is a first exploded view of the handheld fan according to the invention.

FIG. 3 is a second exploded view of the handheld fan according to the invention.

FIG. 4 is a first cross-sectional view of the handheld fan according to the invention.

FIG. 5 is a second cross-sectional view of the handheld fan according to the invention.

FIG. 6 is an overall view of a motor according to the invention.

FIG. 7 is a side view of an impeller according to the invention.

FIG. 8 is an overall view of the impeller according to the invention.

### DETAILED DESCRIPTION OF THE INVENTION

To allow those skilled in the art to gain a better understanding of the solutions of the invention, the technical solutions of the embodiments of the invention will be described clearly and completely below in conjunction with the accompanying drawings of the embodiments. Obviously, the embodiments in the following description are merely illustrative ones, and are not all possible embodiments of the invention. All embodiments obtained by those ordinarily skilled in the art without creative labor should also fall within the protection scope of the invention.

The terms such as “comprise”, “provided with” and any transformations thereof in the description and claims of the invention refer to non-exclusive inclusion. For example, the expression of comprising a series of units, processes, systems, products or devices included is not definitely limited to these units, processes, systems, products or devices that are clearly listed, and may also comprise units, processes, systems, products or devices that are not clearly defined or other inherent units, processes, systems, products or devices.

The terms such as “install”, “dispose”, “provided with”, “connect”, “link” or “sleeve” should be broadly understood. For example, “connect” may refer to fixed connection, detachable connection, or integral configuration; or, mechanical connection or electrical connection; or direct connection, or indirect connection via an intermediate medium, or internal communication of two devices, elements or constituent parts. Those ordinarily skilled in the art may understand the specific meanings of these terms in the invention as the case may be. The expression of “connect” or “link” may refer to direct connection or indirect connection via an intermediate component. Unless otherwise expressly stated, one element is “provided with”, or “arranged”, “disposed” or “connected to” another element, it shall not exclusive of the possibility that the two elements are of an integrated structure.

In addition, spatially opposite terms such as “bottom” and “top” may be used to describe the relationship of one element and/or feature and another (one or more) element and/or (one or more) features, such as the relationship shown in the figures. It should be understood that the spatially opposite terms are intended to include other directions in use and/or during operation of the device in addition to those in the figures. For example, if the device in the figures is turned over, an element described as “front” may be defined as “behind” another element or feature. The device may be redirected (for example, the device may be rotated by 90°, and the spatially opposite expressions used in this specification are interpreted accordingly.

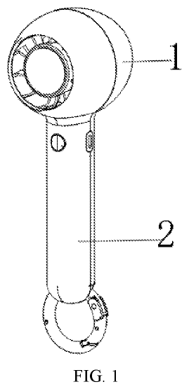

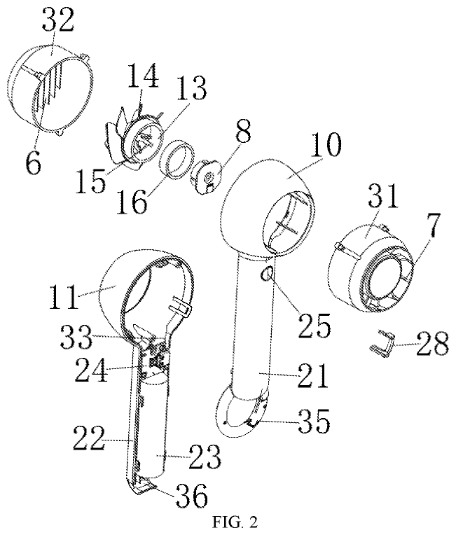

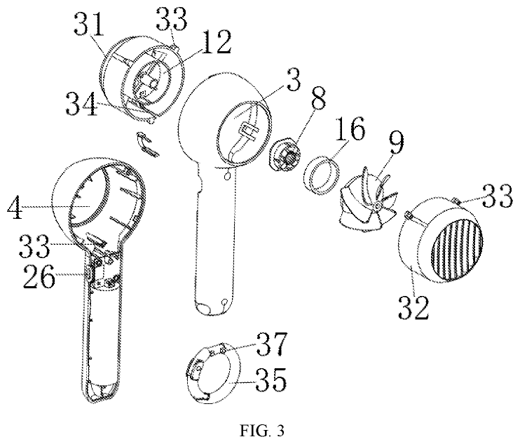

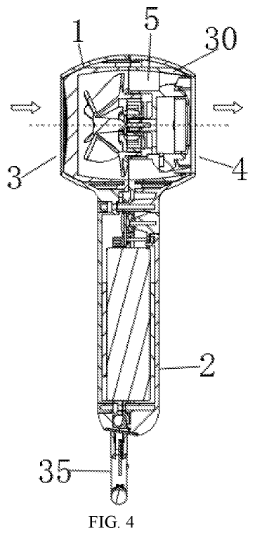

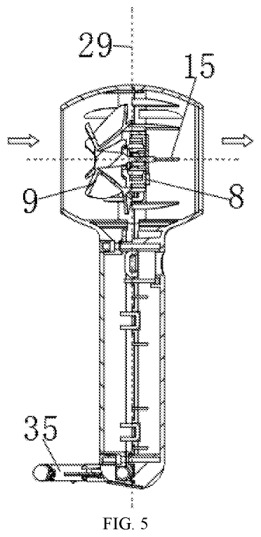

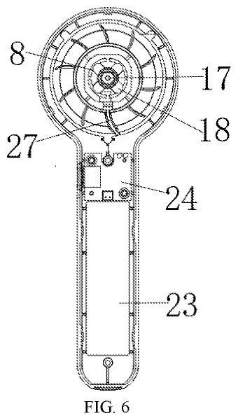

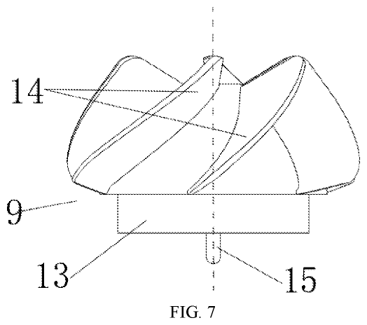

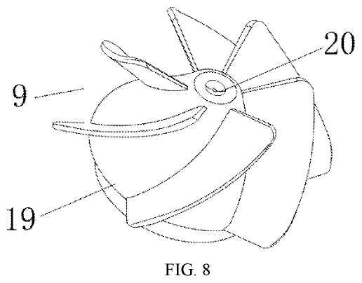

Referring to FIG. 1-FIG. 8, a handheld fan with a fairing comprises a fan head 1 and a handle 2, wherein the fan head 1 is cylindrical and is provided with an air inlet 3, an air outlet 4, and a fluid passage 5 connecting the air inlet 3 and the air outlet 4, air inlet vanes 6 and air outlet vanes 7 are disposed in the air inlet 3 and the air outlet 4 respectively, a motor 8 and an impeller 9 are disposed in the fluid passage 5, and the motor 8 is able to drive the impeller 9 to rotate to enable air to flow along the air inlet 3, the fluid passage 5 and the air outlet 4.

Specifically, the fan head 1 comprises a front cover 10 and a rear cover 11 that are fixedly connected, the air outlet 4 is formed in the front cover 10 and is directly or indirectly connected to the air outlet vanes 7, and the air inlet 3 is formed in the rear cover 11 and is directly or indirectly connected to the air inlet vanes 6.

In this embodiment, the front cover 10 and the rear cover 11 are both cylindrical and are detachably and fixedly connected in a front-back direction through a buckle to form the fan head 1, the air inlet vanes 6 and the rear cover 11 are integrally formed or fixedly connected, the air outlet vanes 7 and the front cover 10 are integrally formed or fixedly connected, the center of the front cover 10 is fixedly connected to a cavity 12 through the air outlet vanes 7, the motor 8 is installed in the cavity 12, and the fluid passage 12 is formed between an outer side of the cavity 12 and the fan head 1; and under the restraint of the cavity 12, the fluid passage 5 located at the position of the air outlet 4 has the smallest cross-sectional, the fluid passage 5 has different cross-sectional areas in front of and behind the impellers 9, and the cross-sectional area of the fluid passage 5 close to the air inlet is greater than the cross-sectional area of the fluid passage 5 close to the air inlet, so that air is gathered in the fluid passage 5, and an air flow blown out of the air outlet 4 is more concentrated.

Preferably, to extend the length of the air flow gathered in the fluid passage 5 without increasing the size of the fan head 1, the impeller 9 faces the air inlet 3 and is located in the rear cover 11; and to reduce the size and weight of the fan, the motor 8 is a DC brushless external rotor motor 8.

Specifically, the impeller 9 comprises a hub 13 and blades 14, wherein a rotary shaft 15 and a magnet 16 are disposed in the hub 13, the rotary shaft 15 is located at the center of the hub 13, the magnet 16 is located on an edge of the hub 13, and the multiple blades 14 are spirally disposed on an outer surface of the hub 13 and are spaced apart from each other; the motor 8 comprises a stator, a shaft hole 17 allowing the rotary shaft 15 to be inserted therein is formed in the center of the stator, a coil 18 is disposed outside the shaft hole 17, and when installed, the rotary shaft 15 is inserted into the shaft hole 17, the coil 18 is sleeved with the magnet 16, and when the stator is powered on, the coil 18 generates a magnetic field to enable the magnet 16 to drive the impeller 9 to rotate, and the impeller 9 is connected to the cavity 12 or the motor 8 through the magnetic force between the magnet 16 and the stator, so that installation is more convenient; and compared with a common motor 8, the motor is smaller in size and lower in weight, and the overall size and weight of the fan head 1 can be reduced, and the fan will not be top-heavy when used.

Preferably, the hub 13 is shaped like a cone or a frustum cone, and has a first end 19 with a maximum diameter and a second end 20 with a minimum diameter, the blades 14 are obliquely installed on a surface of the hub 13, the cross-sections of every two adjacent blades 14 overlap in the direction of the rotary shaft 15, and each blade 14 has different widths 14 at different positions of the hub 13. In this embodiment, the width of the blades 14 at the first end 19 is not greater than that of the blades 14 at the second end 20.

In this embodiment, the handle 2 is fixedly connected to bottoms of the front cover 10 and the rear cover 11, and comprises a front shell 21 and a rear shell 23, the front shell 21 and the front cover 10 are formed integrally, the rear shell 22 and the rear cover 11 are formed integrally, a battery 23 and a controller 24 connected to the battery 23 are disposed in the handle 2, the controller 24 is connected to a switch 25 and a charging port 26, and the front cover 10, the rear cover 11 and the handle 2 are communicated integrally to allow a wire to pass through to electrically connect the battery 23, the controller 24 and the motor 8.

To conceal the wire, one air outlet vane 6 at the lower end is provided with a wire duct 27, and two ends of the wire duct 27 are communicated with the handle 2 and the cavity 12 respectively; when installed, the wire is installed in the wire duct 27 and is isolated from the fluid passage 5 through the wire duct 27. Preferably, a shield 28 is disposed on the wire duct 27. After being installed, the shield 28 covers the wire duct 27, so that the wire cannot be seen via the air inlet 3 and the wire outlet 4 and is hidden, which makes the entire fan more attractive and prevents the wire from being broken by an external object.

Preferably, a connecting line of the center of the motor 8 and the handle 2 coincides with an axis 29 of the handle 2 or is located in front of the axis 29 of the handle 2. When the handheld fan is held by hand for use, the center of gravity of the fan is located on or near the axis 29 of the handle 2, and the situation that the fan inclines backwards due to the fact that the axis of the fan is located back is avoided. In this embodiment, the axis 29 of the handle 2 is perpendicular to the fan head 1, and the center of the motor 8 is located in front of the axis 29 of the handle 2.

In this embodiment, to make the air flow blown out of the air outlet 4 more concentrated, the cross-section of the fan head 1 is arc, so that the width of the air outlet 4 is smaller than that of the impeller 9, and the first end 19 of the hub 13 is located at a position, with the maximum cross-sectional area, of the fan head; or, the cross-sectional area of the air outlet 4 is smaller than that of the air inlet 3, and the fluid passage 5 is located on the cross-sectional area of the impeller 9.

Preferably, the air inlet vanes 6 are in a grid shape, the air outlet vanes 7 are curved, and outer surfaces of the air outlet vanes 7 are concaved inwards at the air outlet 4 to form a step.

In other embodiments, to facilitate the formation and installation of the fan, a fairing 30 is disposed on inner sides of the front cover 10 and the rear cover 11, and the fairing 30 is cylindrical and has a size matching that of the front cover 10 and the rear cover 11, so that the fairing 30 can be inserted into the front cover 10 and the rear cover 11 to be installed. Limiting mechanisms 33 are disposed between the fairing 30 and the front cover 10, as well as between the fairing and the rear cover 11 to prevent the fairing 30 from rotating in the fan head 1.

Specifically, the fairing 30 at least comprises a front fairing portion 31 and a rear faring portion 32, wherein an end of the front fairing portion 31 and the air outlet vanes 7 are integrally formed or fixedly connected, an end of the rear fairing portion 32 and the air inlet vanes 6 are integrally formed or fixedly connected, the front fairing portion 31 is connected to the cavity 12 through the air outlet vanes 7, and the fluid passage 5 is formed between the cavity 12 and the front fairing portion 31; and after the fan is installed, the motor 8 is located in the front fairing portion 31, the impeller 9 is located outside the cavity 12 and in the rear fairing portion 32.

Preferably, a hole 34 allowing the wire to penetrate through is formed in a lower end of the front fairing portion 31 or the rear fairing portion 32, and is communicated with the wire duct 27 and the handle 2, and the shield 28 covers the hole 34 after being installed.

In this embodiment, to make the fan easy to carry, a ring 35 or a string is disposed on the handle 2. Users hang the fan on their neck through the string or hang the fan on a backpack through the ring 35.

Preferably, a bottom of the handle 2 is a plane, so that the fan can be erected on a horizontal table to be used.

In this embodiment, a locating mechanism is disposed between the ring 35 and the handle 2, and is used to locate the ring 35 behind a horizontal direction, and when the fan is erected for use, the ring 35 forms a support seat, so that the fan can be stably supported on the horizontal table.

Specifically, a groove 36 is formed in the front shell 21 or the rear shell 22, the ring 35 is disposed in the groove 36, and is installed at the bottom of the handle 2 after the front shell 21 and the rear shell 22 are and connected through the buckle, a protrusion 39 is disposed on the ring 35 and is attached to an inner wall of the front shell 21 or the rear shell 22, and when the ring 35 rotates to a support position, the protrusion 37 is attached to the inner wall of the front shell 21 or the rear shell 22 to limit the ring 35, so that the ring is prevented from continuing rotate backwards and upwards.

The above contents in this specification are merely used to illustratively describe the invention. Various amendments, supplements or similar substitutions of these specific embodiments described above made by those skilled in the art without departing from the contents in the specification or exceeding the scope defined by the appended claims should also fall within the protection scope of the invention.

What is claimed is:

1. A handheld fan with a fairing, comprising a fan head and a handle, the fan head being cylindrical and being provided with an air inlet, an air outlet, and a fluid passage connecting the air inlet and the air outlet, air inlet vanes and air outlet vanes being disposed in the air inlet and the air outlet respectively, wherein the fan head comprises a front cover and a rear cover that are fixedly connected, a fairing is disposed on inner sides of the front cover and the rear cover, a center of the fairing is connected to a cavity through the air outlet vanes, a motor is installed in the cavity, an impeller is located outside the cavity after being connected to the motor, the fluid passage is formed between the cavity and the fairing, and the motor is able to drive the impeller to rotate to allow air to flow along the air inlet, the fluid passage and the air outlet.

2. The handheld fan with a fairing according to claim 1, wherein a cross-sectional area of the air outlet is smaller than a cross-sectional area of the air inlet and a cross-sectional area of the fluid passage in a position of the impeller.

3. The handheld fan with a fairing according to claim 2, wherein the fairing at least comprises a front fairing portion and a rear fairing portion, the cavity and the motor are located in the front fairing portion, the impeller is located in the rear fairing portion, and limiting mechanisms for preventing circumferential rotation are disposed between the front fairing portion and the front cover, as well as between the rear fairing portion and the rear cover.

4. The handheld fan with a fairing according to claim 3, wherein the handle is fixedly connected to bottoms of the front cover and the rear cover, the front cover, the rear cover and the handle are internally communicated, a battery and a controller connected to the battery are disposed in the handle, the controller is connected to a switch and a charging port, and the fairing is provided with a hole allowing a wire to penetrate through to electrically connect the motor and the controller.

5. The handheld fan with a fairing according to claim 4, wherein a wire duct is formed in one said air outlet vane and is communicated with the hole, the wire enters the wire duct after penetrating through the hole, and is isolated from the fluid passage, and a shield is disposed on the wire duct, and covers the wire duct after being installed.

6. The handheld fan with a fairing according to claim 1, wherein the motor is a DC brushless external rotor motor, the impeller comprises a hub and blades, a rotary shaft and a magnet are disposed in the hub, the blades are fixed on an outer side of the hub, and when the impeller and the motor are installed, the rotary shaft is inserted into the motor, and the magnet is located on an outer side of the motor.

7. The handheld fan with a fairing according to claim 6, wherein the multiple blades are spirally arranged and are spaced apart from each other, and cross-sections of every two adjacent said blades overlap in a direction of the rotary shaft;
and/or, each said blade has different widths at different positions of the hub, and a width of the blades at a first end is not greater than that of the blades at a second end.

8. The handheld fan with a fairing according to claim 7, wherein the hub is shaped like a cone or a frustum cone, and has the first end with a maximum diameter and the second end with a minimum diameter, and the first end is located at a position, with a maximum cross-sectional width, of the fan head.

9. The handheld fan with a fairing according to claim 8, wherein the blades extend towards the air inlet and the motor is located downstream in an air flow direction.

10. The handheld fan with a fairing according to claim 1, wherein the handle is rotatably connected to a ring, a locating mechanism is disposed between the ring and the handle, and when the ring is located at a support position through the locating mechanism, the fan is erected or approximately erected on a horizontal table.
